(19) United States
(12) Patent Application Publication
(10) Pub. No.: US 2026/0081830 A1
(43) Pub. Date: Mar. 19, 2026

(54) COMMUNICATION NETWORK SYSTEM AND METHOD FOR CHANGING COMMUNICATION SETTINGS DURING NETWORK UPDATE

(71) Applicant: TOYOTA JIDOSHA KABUSHIKI KAISHA, Toyota-shi (JP)

(72) Inventor: Taiki MIZUTANI, Miyoshi-shi (JP)

(73) Assignee: TOYOTA JIDOSHA KABUSHIKI KAISHA, Toyota-shi (JP)

(21) Appl. No.: 19/252,534

(22) Filed: Jun. 27, 2025

(30) Foreign Application Priority Data
Sep. 13, 2024 (JP) 2024-159134

(51) Int. Cl. H04L 41/082; H04L 12/40

(52) U.S. Cl. CPC H04L 41/082; H04L 12/40

(57) ABSTRACT

The communication network system sends an offer message to the first communication bus by the providing-side electronic control unit when the network is updated. The electronic control unit selects whether or not to receive a service message provided by the providing-side electronic control unit by confirming the offer message. The receiving-side electronic control unit that has selected to receive the service message changes the settings to receive the service message. The receiving-side electronic control unit sends a subscription message to the first communication bus. Upon receiving the subscription message, the providing-side electronic control unit starts providing the service by the service message.

### CROSS-REFERENCE TO RELATED APPLICATION

This application claims priority to Japanese Patent Application No. 2024-159134 filed on Sep. 13, 2024, incorporated herein by reference in its entirety.

### BACKGROUND

### 1. Technical Field

The present disclosure relates to a communication network system and a method for changing communication settings during network update.

### 2. Description of Related Art

A communication network system disclosed in Japanese Unexamined Patent Application Publication (Translation of PCT Application) No. 2018-522487 (JP 2018-522487 A) includes a plurality of subscriber stations connected to each other. An identifier is assigned to a message transmitted by the subscriber station in the communication network system. When a new subscriber station is connected and the network is updated, the communication network system assigns a reserved identifier as a resource for dynamic communication to a message to be transmitted by the new subscriber station. Therefore, the network system can perform communication that was not expected at the design stage.

### SUMMARY

In the dynamic network that can be updated, communication that was not expected at the design stage of the network system may increase. Therefore, a communication load exceeding a load expected at the design stage of the network system may be imposed.

A first aspect of the present disclosure relates to a communication network system in which a plurality of electronic control units is connected by a communication bus, each of the electronic control units selects a communication message to be received among a plurality of the communication messages transmitted in the communication bus by checking first identifiers included in the communication messages, and an application stored in the electronic control unit uses data included in the received communication message.

The communication network system is configured such that, when a network is updated, a providing-side electronic control unit that provides a service among the plurality of electronic control units transmits, to the communication bus, an offer message including a service identifier unique to the service to be provided and having the first identifier to be received by all the electronic control units.

The communication network system is configured such that each of the electronic control units makes selection as to whether to receive the communication message for the service to be provided by the providing-side electronic control unit by checking the service identifier included in the received offer message.

The communication network system is configured such that a receiving-side electronic control unit that has made selection to receive the communication message for the service to be provided by the providing-side electronic control unit among the plurality of electronic control units changes settings to receive the communication message having, as the first identifier, a value generated based on a specific rule from a value of the service identifier included in the received offer message.

The communication network system is configured such that the receiving-side electronic control unit transmits, to the communication bus, a subscription message including the service identifier included in the received offer message and having the first identifier to be received by all the electronic control units.

The communication network system is configured such that, when the providing-side electronic control unit receives the subscription message including the service identifier included in the offer message transmitted by the providing-side electronic control unit, the providing-side electronic control unit starts to provide the service using the communication message having, as the first identifier, the value generated based on the specific rule from the value of the service identifier included in the offer message.

A second aspect of the present disclosure relates to a method for changing communication settings during network update in a communication network system in which a plurality of electronic control units is connected by a communication bus, each of the electronic control units selects a communication message to be received among a plurality of the communication messages transmitted in the communication bus by checking first identifiers included in the communication messages, and an application stored in the electronic control unit uses data included in the received communication message.

The method for changing communication settings during network update includes, when a network is updated, performing, by a processing circuit of a providing-side electronic control unit that provides a service among the plurality of electronic control units, a process of transmitting, to the communication bus, an offer message including a service identifier unique to the service to be provided and having the first identifier to be received by all the electronic control units.

The method for changing communication settings during network update includes making, by a processing circuit of each of the electronic control units, selection as to whether to receive the communication message for the service to be provided by the providing-side electronic control unit by checking the service identifier included in the received offer message.

The method for changing communication settings during network update includes changing, by a processing circuit of a receiving-side electronic control unit that has made selection to receive the communication message for the service to be provided by the providing-side electronic control unit among the plurality of electronic control units, settings to receive the communication message having, as the first identifier, a value generated based on a specific rule from a value of the service identifier included in the received offer message.

The method for changing communication settings during network update includes performing, by the processing circuit of the receiving-side electronic control unit, a process of transmitting, to the communication bus, a subscription message including the service identifier included in the received offer message and having the first identifier to be received by all the electronic control units.

The method for changing communication settings during network update includes, when the processing circuit of the providing-side electronic control unit receives the subscription message including the service identifier included in the offer message transmitted by the providing-side electronic control unit, starting, by the providing-side electronic control unit, to provide the service using the communication message having, as the first identifier, the value generated based on the specific rule from the value of the service identifier included in the offer message.

With the communication network system and the method for changing communication settings during network update, it is possible to suppress an increase in the communication load imposed on the communication network system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram schematically illustrating a communication network system according to an embodiment;

FIG. 2 is a sequence diagram illustrating a flow of processing executed by the communication network system;

FIG. 3 is a schematic diagram illustrating an exemplary data configuration of an offer message and a subscription message; and

FIG. 4 is a schematic diagram illustrating an example of a data configuration of a service message.

### DETAILED DESCRIPTION OF EMBODIMENTS

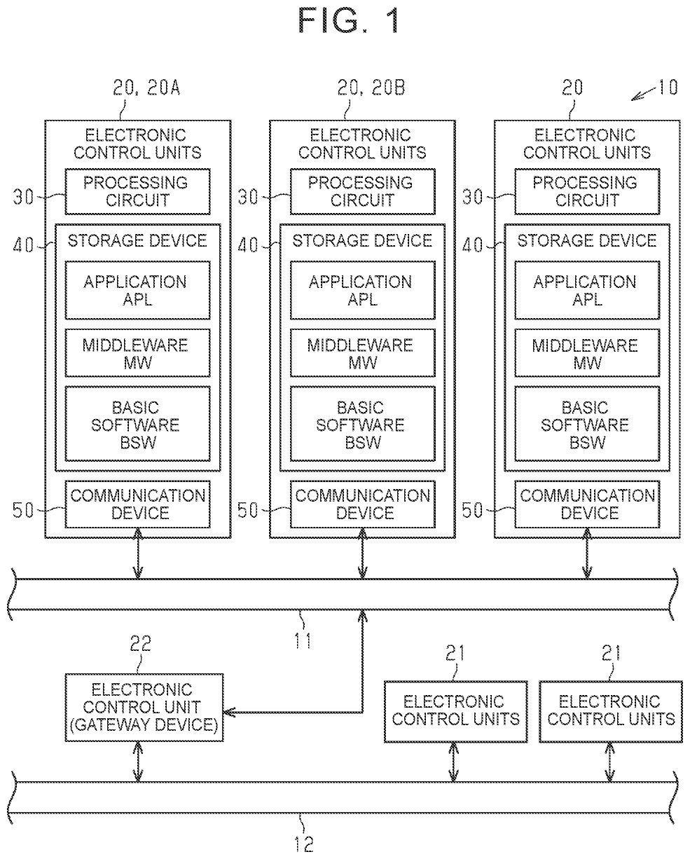

Hereinafter, an embodiment of a communication network system will be described with reference to FIG. 1 to FIG. 4. First, the configuration of the communication network system 10 will be described, FIG. 1 shows a communication network system 10 mounted on a vehicle. The communication network system 10 includes a plurality of electronic control units 20. Each of the plurality of electronic control units 20 is connected by a first communication bus 11. The first communication bus 11 transmits communication messages based on CAN protocol, which is the communication protocol defined in CAN (controller area network). The communication message transmitted based on CAN protocol includes CAN-ID as the first identifier. CAN-ID is used to identify the content of the communication message.

The communication network system 10 includes a plurality of electronic control units 21. Each of the plurality of electronic control units 21 is connected by a second communication bus 12. The second communication bus 12 transmits communication messages based on Ethernet protocol, which is a communication protocol defined in Ethernet. The communication message transmitted according to Ethernet protocol has an identifier for the IP (Internet protocol) communication.

The communication network system 10 comprises an electronic control unit 22. The electronic control unit 22 is a gateway device connected to both the first communication bus 11 and the second communication bus 12. The electronic control unit 22 relays communication messages between the first communication bus 11 and the second communication bus 12. The electronic control unit 22 has a function of converting the first identifier included in the communication message and the identifier for IP communication at the time of relaying the communication message.

### Configuration of Electronic Control Unit 20

Each of the plurality of electronic control units 20 connected to the first communication bus 11 includes a processing circuit 30, a storage device 40, and a communication device 50. The storage device 40 stores an application APL, a middleware MW, and a basic software BSW. The electronic control unit 20 provides a service corresponding to the application APL by the processing circuit 30 executing the application APL stored in the storage device 40. An application APL is software running on a middleware MW. A middleware MW is software running on a basic software BSW.

The application APL is software for causing each of the electronic control units 20 to perform a particular function. The application APL uses the data included in the communication message received by the electronic control unit 20. Certain functions performed by the electronic control unit 20 include a function of detecting a velocity of a vehicle and a ADAS (Advanced driver assistance system) that is an advanced driving assistance system. The basic software BSW is software for performing basic control of hardware constituting the electronic control unit 20. The middleware MW is software that causes each of the electronic control units 20 to perform a particular function according to the application APL stored in the electronic control unit 20 by mediating the basic software BSW and the application APL.

The communication device 50 outputs the communication message to the first communication bus 11. A communication message is input to the communication device 50 from the first communication bus 11. The electronic control unit 20 receives a communication message including data used by the application APL among the inputted communication messages. Specifically, the electronic control unit 20 selects whether or not to receive the communication message by the basic software BSW confirming the first identifier included in the communication message.

### Processing at Network Update

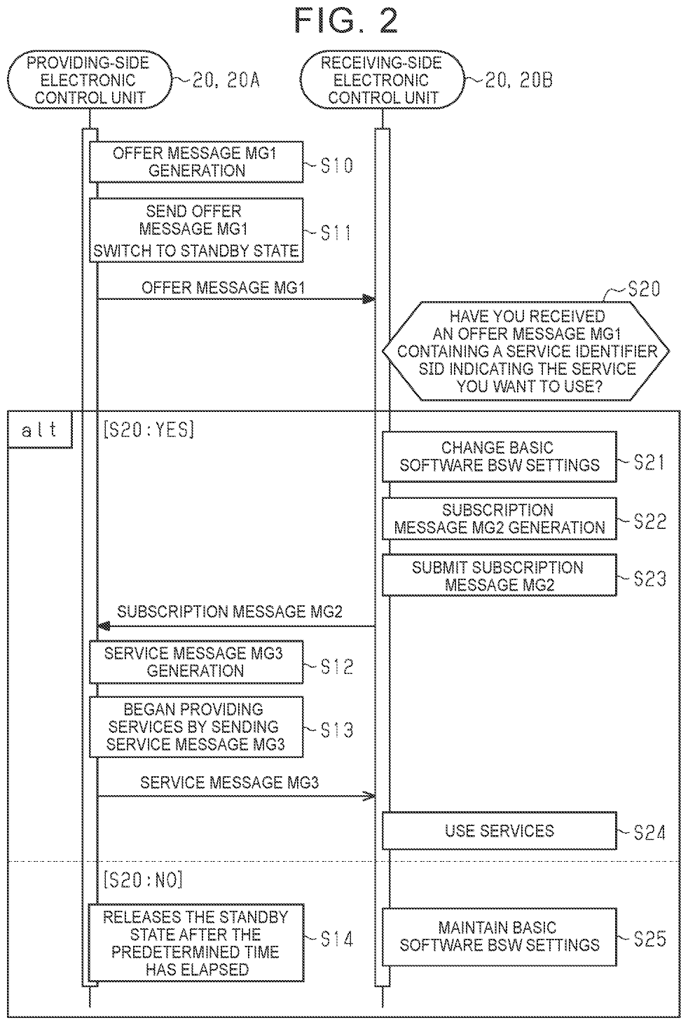

The communication network system 10 is a dynamic network capable of updating a network. As illustrated in FIG. 2, the communication network system 10 changes the communication settings of the network when the network is updated.

When the network is updated, the electronic control unit 20 first executes S10 process. In S10 process, the electronic control unit 20 generates an offer message MG1 as the providing-side electronic control unit 20A.

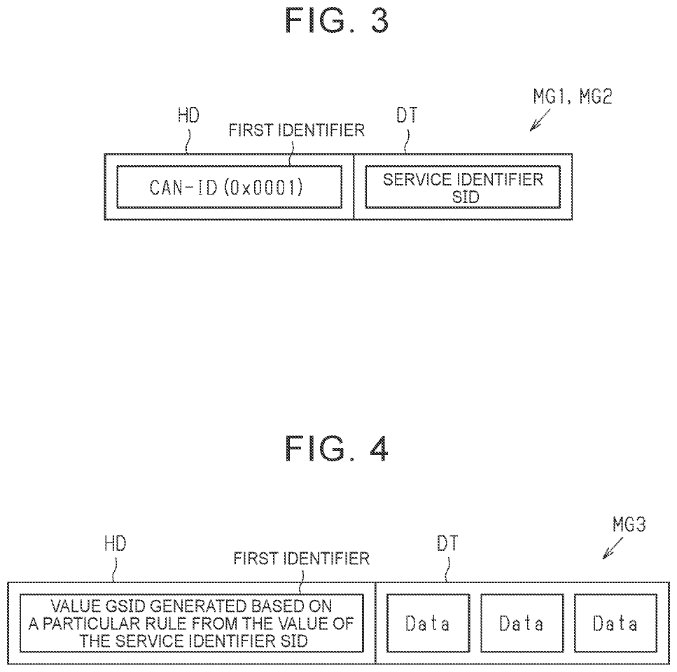

As shown in FIG. 3, the offer message MG1 includes a header area HD and a data area DT. In the header area HD, a CAN-ID is stored as a first identifier. The first identifier in the offer message MG1 is “0x0001”. A communication message including a “0x0001” in the first identifier is received by all the electronic control units 20 connected to the first communication bus 11. As such, the offer message MG1 is received by all electronic control units 20 connected to the first communication bus 11. Data indicating the service identifier SID is stored in the data area DT. The service identifier SID is an identifier unique to the service provided by the providing-side electronic control unit 20A. In the present embodiment, the service provided by the providing-side electronic control unit 20A is “service A”. The service identifier SID corresponding to “Service A” is “0x1123”. Therefore, the service identifier SID in the offer message MG1 generated by the providing-side electronic control unit 20A is “0x1123”. After generating the offer message MG1 with the first identifier, the providing-side electronic control unit 20A advances the process to S11.

In S11 process, the providing-side electronic control unit 20A transmits an offer message MG1 with a first identifier to the first communication bus 11. After that, the providing-side electronic control unit 20A shifts to a standby status in which a subscription message MG2 to be described later can be received from the first communication bus 11.

Upon receiving the offer message MG1, the electronic control unit 20 executes S20 process as the receiving-side electronic control unit 20B. In S20 process, the receiving-side electronic control unit 20B selects whether to receive a communication message for the service provided by the providing-side electronic control unit 20A by confirming the service identifier SID included in the received offer message MG1. Specifically, it is decided to receive a communication message about the service provided by the providing-side electronic control unit 20A in the following cases. In this case, the middleware MW of the receiving-side electronic control unit 20B receives the offer message MG1 including the service identifier SID indicating the service desired to be used by the application APL.

The service that the application APL desires to use is determined at the time of designing the communication network system 10 or updating the network. In the embodiment illustrated in FIG. 2, the application APL stored in the receiving-side electronic control unit 20B desires to use “service A”. Therefore, the middleware MW determines whether or not an offer message MG1 including “0x1123”, which is a service identifier SID indicating “Service A”, is received in the data area DT. If the receiving-side electronic control unit 20B receives an offer message MG1 containing “0x1123” (S20: YES), the receiving-side electronic control unit 20B decides to receive a communication message for the service provided by the providing-side electronic control unit 20A. Thereafter, the process proceeds to S21.

In S21 process, the receiving-side electronic control unit 20B changes the settings of the basic software BSW. Specifically, the middleware MW changes the setting of the basic software BSW so as to receive a communication message with the value GSID generated based on the particular rule from the value of the service identifier SID indicating “service A”as the first identifier.

The electronic control unit 20 uses the last two digits in the value of the service identifier SID as a value GSID generated based on a particular rule from the value of the service identifier SID. That is, when the value of the service identifier SID is “0x1123”, the value GSID generated based on the particular rule from the value of the service identifier SID is “0x0023”.

By the middleware MW changing the settings of the basic software BSW, the basic software BSW selects a communication message whose first identifier is “0x0023” as the communication message to be received. This allows the receiving-side electronic control unit 20B to receive a communication message whose first identifier is “0x0023”.After changing the basic software BSW settings in S21 process, the process proceeds to S22.

In S22 process, the receiving-side electronic control unit 20B generates a subscription message MG2. As shown in FIG. 3, the subscription message MG2 includes a header area HD and a data area DT. In the header area HD, a CAN-ID is stored as a first identifier. The first identifier in the subscription message MG2 is “0x0001”. As such, the subscription message MG2 is received by all electronic control units 20 connected to the first communication bus 11. Data indicating the service identifier SID is stored in the data area DT of the subscription message MG2. The service identifier SID stored in the data area DT of the subscription message MG2 is the same as the service identifier SID stored in the data area DT of the offer message MG1 received by the receiving-side electronic control unit 20B in S20 process. Therefore, the service identifier SID in the subscription message MG2 is “0x1123”. After the receiving-side electronic control unit 20B generates the subscription message MG2, it proceeds to S23. In S23 process, the receiving-side electronic control unit 20B sends a subscription message MG2 with a first identifier to the first communication bus 11.

The providing-side electronic control unit 20A executes S12 process when receiving the subscription message MG2 including the service identifier SID included in the offer message MG1 transmitted by the providing-side electronic control unit 20A. In S12 process, the providing-side electronic control unit 20A generates a service message MG3. The service message MG3 is a communication message for a service provided by the providing-side electronic control unit 20A.

As shown in FIG. 4, the service message MG3 includes a header area HD and a data area DT. The service message MG3 includes, as a first identifier in the header area HD, a value GSID generated based on a particular rule from the value of the service identifier SID included in the offer message MG1 by the providing-side electronic control unit 20A. The electronic control unit 20 uses the last two digits in the value of the service identifier SID as a value GSID generated based on a particular rule from the value of the service identifier SID. If the value of the service identifier SID is “0x1123”, the value GSID generated based on the particular rule from the value of the service identifier SID is “0x0023”. Therefore, the first identifier stored in the header area HD of the service message MG3 is “0x0023”.

The service message MG3 includes, in the data area DT, data related to a service provided by the providing-side electronic control unit 20A. That is, the data area DT of the service message MG3 stores the data of “service A”. After the providing-side electronic control unit 20A generates the service message MG3, the process proceeds to S13.

In S13 process, the providing-side electronic control unit 20A transmits a service message MG3 to the first communication bus 11. Accordingly, the providing-side electronic control unit 20A starts providing the service by the communication message in which the value GSID generated based on the specified rule from the value of the service identifier SID included in the offer message MG1 by the providing-side electronic control unit 20A is attached as the first identifier.

The receiving-side electronic control unit 20B having the basic software BSW setting changed in S21 can receive a communication message whose first identifier is “0x0023”. Therefore, the receiving-side electronic control unit 20B can receive a service message MG3 whose first identifier is “0x0023”. The receiving-side electronic control unit 20B that has received the service message MG3 uses the service provided by the providing-side electronic control unit 20A as a process of S24.

If an offer message MG1 containing a service identifier SID indicating the service to be used is not received (S20: NO), the receiving-side electronic control unit 20B maintains the basic software BSW settings as a process of S25.

When the providing-side electronic control unit 20A does not receive the subscription message MG2 including the service identifier SID included in the offer message MG1 transmitted by the providing-side electronic control unit 20A within the predetermined period, the providing-side electronic control unit 20A cancels the standby state as S14 process. In this case, the providing-side electronic control unit 20A does not transmit the service message MG3 even if it receives the subscription message MG2 including the service identifier SID included in the offer message MG1 transmitted by the providing-side electronic control unit 20A.

### Operations of Present Embodiment

The providing-side electronic control unit 20A receives the subscription message MG2. Then, when it is confirmed that the receiving-side electronic control unit 20B that has selected to receive the communication message regarding the service provided by the providing-side electronic control unit 20A exists, the provision of the service is started. That is, when it is not confirmed that the receiving-side electronic control unit 20B that has selected to receive the communication message regarding the service provided by the providing-side electronic control unit 20A exists, the providing-side electronic control unit 20A does not transmit the communication message regarding the service to the first communication bus 11.

### Effects of Present Embodiment

The communication network system 10 can suppress transmission of unnecessary communication messages to the first communication bus 11. Accordingly, the communication network system 10 can suppress an increase in the communication load imposed on the communication network system 10.

The receiving-side electronic control unit 20B that has selected to receive the service message MG3 changes the settings of the basic software BSW to receive the service message MG3. Therefore, the communication network system 10 can reduce the load on the electronic control unit 20 as compared with the communication network system that causes the electronic control unit 20 to determine whether or not the communication message is necessary every time the communication message is received.

In the communication network system 10, the electronic control unit 20 stores a middleware MW and a basic software BSW. The basic software BSW stored by the electronic control unit 20 selects a communication message to receive. Therefore, the communication network system 10 does not need to implement a function of selecting a communication message to be received for each application APL of a different type.

The electronic control unit 20 connected to the first communication bus 11 in the communication network system 10 transmits communication messages using a CAN protocol as a communication protocol. The communication network system 10 can establish a dynamical network in which an increase in communication loads on the communication network system 10 is suppressed while using a conventional CAN protocol.

The communication network system 10 includes a first communication bus 11 and a second communication bus 12. The first communication bus 11 transmits communication messages using a CAN protocol as a communication protocol. The second communication bus 12 transmits communication messages using an Ethernet protocol as a communication protocol. The electronic control unit 22 is a gateway device connected to both the first communication bus 11 and the second communication bus 12. The electronic control unit 22 relays communication messages between the first communication bus 11 and the second communication bus 12. Furthermore, the electronic control unit 22 has a function of converting the first identifier included in the communication message and the identifier for IP communication at the time of relaying the communication message. Accordingly, the communication network system 10 can establish a dynamic network in which an increase in the communication load is suppressed even among a plurality of communication buses having different communication protocols.

The following steps (S11) are included in the methods for changing the communication settings at the time of updating the network performed by the communication network system 10. In the step (S11), when the network is updated, the processing circuit 30 of the providing-side electronic control unit 20A that provides the service among the plurality of electronic control units 20 executes a process of transmitting the offer message MG1 to the first communication bus 11. The offer message MG1 includes a service identifier SID unique to the service to be provided, and has a first identifier received by all the electronic control units 20. The following steps (S20) are included in the methods for changing the communication settings at the time of updating the network performed by the communication network system 10. In S20, the processing circuit 30 included in each of the plurality of electronic control units 20 checks the service identifier SID included in the received offer message MG1. Then, whether or not to receive a communication message regarding the service provided by the providing-side electronic control unit 20A is selected. The following steps (S21) are included in the methods for changing the communication settings at the time of updating the network performed by the communication network system 10. In a step (S21), the processing circuit 30 changes the setting to receive the communication message with the value GSID generated based on the particular rule from the value of the service identifier SID included in the received offer message MG1 as the first identifier. The processing circuit 30 is the processing circuit 30 of the receiving-side electronic control unit 20B that has selected, among the plurality of electronic control units 20, to receive a communication message for the service provided by the providing-side electronic control unit 20A. The following steps (S23) are included in the methods for changing the communication settings at the time of updating the network performed by the communication network system 10. In steps (S23), the processing circuit 30 of the receiving-side electronic control unit 20B performs a process of sending a subscription message MG2 to the first communication bus 11. The subscription message MG2 includes the service identifier SID included in the received offer message MG1 and is assigned a first identifier that is received by all the electronic control units 20. The following steps (S13) are included in the methods for changing the communication settings at the time of updating the network performed by the communication network system 10. In a step (S13), the processing circuit 30 of the providing-side electronic control unit 20A starts providing the service by the service message MG3 when receiving the subscription message MG2. The subscription message MG2 includes the service identifier SID included in the offer message MG1 transmitted by the providing-side electronic control unit 20A. The service message MG3 is a communication message in which a value GSID generated based on a particular rule from the value of the service identifier SID included in the offer message MG1 by the providing-side electronic control unit 20A is attached as a first identifier. By executing the method of changing the communication setting at the time of updating the network, the communication network system 10 causes the providing-side electronic control unit 20A to start providing the service when the providing-side electronic control unit 20A receives the subscription message MG2 and confirms that there is the receiving-side electronic control unit 20B that has selected to receive the communication message about the service provided by the providing-side electronic control unit 20A. That is, the communication network system 10 does not cause the providing-side electronic control unit 20A to transmit the communication message about the service to the first communication bus 11 when it is not confirmed that the receiving-side electronic control unit 20B that has selected to receive the communication message about the service provided by the providing-side electronic control unit 20A exists by executing the above-described method of changing the communication setting at the time of network updating. The method of changing the communication setting at the time of the network update described above can suppress transmission of unnecessary communication messages to the communication bus even if the network is updated. Thus, the method of changing the communication setting at the time of network update described above can suppress an increase in the communication load on the communication network system 10.

### Modifications

The present embodiment can be realized with the following modifications. The present embodiment and the following modifications can be combined with each other within a technically consistent range to be realized.

The service identifier SID and the value GSID generated based on the particular rule from the value of the service identifier SID may be the same value. That is, in this case, a specific rule is a rule that outputs the same value.

The electronic control unit 20 may not store the middleware MW and the basic software BSW. The electronic control unit 20 may select a communication message to be received from the plurality of communication messages transmitted by the application APL on the first communication bus 11.

In the above embodiments, the combination of the communication protocols of the plurality of communication buses constituting the communication network system is not limited to the combination of CAN and Ethernet. For example, it may be a combination of CAN and FlexRay.

The electronic control unit 20 may be configured as a circuitry including one or more processors that execute various processes in accordance with a computer program (software). Note that the electronic control unit 20 may be configured as a circuit including one or more dedicated hardware circuits such as an application-specific integrated circuit (ASIC) that executes at least some of the various processes, or a combination thereof. The processor includes a CPU and a memory such as a random access memory (RAM) and a ROM. The memory stores a program code or an instruction configured to execute the CPU to perform processes. The memory, that is, the computer-readable medium includes any available media that can be accessed by a general purpose or special purpose computer.

What is claimed is:

1. A communication network system in which a plurality of electronic control units is connected by a communication bus, each of the electronic control units selects a communication message to be received among a plurality of the communication messages transmitted in the communication bus by checking first identifiers included in the communication messages, and an application stored in the electronic control unit uses data included in the received communication message,
the communication network system being configured such that:
when a network is updated,
a providing-side electronic control unit that provides a service among the plurality of electronic control units transmits, to the communication bus, an offer message including a service identifier unique to the service to be provided and having the first identifier to be received by all the electronic control units;
each of the electronic control units makes selection as to whether to receive the communication message for the service to be provided by the providing-side electronic control unit by checking the service identifier included in the received offer message;
a receiving-side electronic control unit that has made selection to receive the communication message for the service to be provided by the providing-side electronic control unit among the plurality of electronic control units changes settings to receive the communication message having, as the first identifier, a value generated based on a specific rule from a value of the service identifier included in the received offer message;
the receiving-side electronic control unit transmits, to the communication bus, a subscription message including the service identifier included in the received offer message and having the first identifier to be received by all the electronic control units; and
when the providing-side electronic control unit receives the subscription message including the service identifier included in the offer message transmitted by the providing-side electronic control unit, the providing-side electronic control unit starts to provide the service using the communication message having, as the first identifier, the value generated based on the specific rule from the value of the service identifier included in the offer message.

2. The communication network system according to claim 1, wherein:
the electronic control unit stores middleware and basic software;
the application operates on the middleware, and the middleware operates on the basic software; and
the basic software selects the communication message to be received among the plurality of communication messages transmitted in the communication bus.

3. The communication network system according to claim 1, wherein a controller area network protocol is used as a communication protocol to transmit the communication messages.

4. The communication network system according to claim 1, wherein:
the communication bus includes a first communication bus and a second communication bus, the first communication bus being configured to transmit the communication messages using a controller area network protocol as a communication protocol, the second communication bus being configured to transmit the communication messages using an Ethernet protocol as a communication protocol;
at least one electronic control unit out of the plurality of electronic control units is a gateway device connected to both the first communication bus and the second communication bus; and
the gateway device has a function of relaying the communication message between the first communication bus and the second communication bus, and performing conversion between the first identifier included in the communication message and an identifier for Internet protocol communication during the relaying.

5. A method for changing communication settings during network update in a communication network system in which a plurality of electronic control units is connected by a communication bus, each of the electronic control units selects a communication message to be received among a plurality of the communication messages transmitted in the communication bus by checking first identifiers included in the communication messages, and an application stored in the electronic control unit uses data included in the received communication message,
the method comprising:
when a network is updated,
performing, by a processing circuit of a providing-side electronic control unit that provides a service among the plurality of electronic control units, a process of transmitting, to the communication bus, an offer message including a service identifier unique to the service to be provided and having the first identifier to be received by all the electronic control units;
making, by a processing circuit of each of the electronic control units, selection as to whether to receive the communication message for the service to be provided by the providing-side electronic control unit by checking the service identifier included in the received offer message;
changing, by a processing circuit of a receiving-side electronic control unit that has made selection to receive the communication message for the service to be provided by the providing-side electronic control unit among the plurality of electronic control units, settings to receive the communication message having, as the first identifier, a value generated based on a specific rule from a value of the service identifier included in the received offer message;
performing, by the processing circuit of the receiving-side electronic control unit, a process of transmitting, to the communication bus, a subscription message including the service identifier included in the received offer message and having the first identifier to be received by all the electronic control units; and
when the processing circuit of the providing-side electronic control unit receives the subscription message including the service identifier included in the offer message transmitted by the providing-side electronic control unit, starting, by the providing-side electronic control unit, to provide the service using the communication message having, as the first identifier, the value generated based on the specific rule from the value of the service identifier included in the offer message.
